(19) United States
(12) Patent Application Publication
(10) Pub. No.: US 2014/0154385 A1
(43) Pub. Date: Jun. 5, 2014

(54) Aerated Sauce and Methods for Manufacturing and Dispensing the Same

(71) Applicants: Jared Hamill, McKinney, TX (US); Bharani Ashokan, McKinney, TX (US); Brian Lottig, McKinney, TX (US); Devid J. Thomas, Frisco, TX (US)

(72) Inventors: Jared Hamill, McKinney, TX (US); Bharani Ashokan, McKinney, TX (US); Brian Lottig, McKinney, TX (US); Devid J. Thomas, Frisco, TX (US)

(21) Appl. No.: 13/691,917

(22) Filed: Dec. 3, 2012

(51) Int. Cl. A23L 1/212

(52) U.S. Cl. CPC A23L 1/2128
USPC 426/564

(57) ABSTRACT

An aerated sauce and method for making and dispensing the same is provided in this disclosure. In one particular embodiment, the aerated sauce comprises pureed fruit, a stabilizer, and entrained gas. In this embodiment, the stabilizer comprises at least one of hydrocolloids, gums, pectins, and gelatins. When the gas, pureed fruit, and stabilizer are mixed together, an aerated sauce with entrained gas is formed. Also disclosed in this document is a method for manufacturing an aerated sauce and a container and method for dispensing an aerated sauce.

### TECHNICAL FIELD

This disclosure relates generally to improvements in fruit and vegetable sauces, such as applesauce, and methods for making and dispensing such sauces.

### BACKGROUND

The present disclosure provides for an improved fruit or vegetable sauce and a method for manufacturing and dispensing the same. In particular, the improvement provides for an aerated sauce that has unique taste and texture, as compared to conventional sauces. Some of the new sauces may also have reduced caloric content.

A common fruit or vegetable sauce is applesauce.

As defined and identified by the U.S. Food and Drug Administration and cited as 21CFR145.110, canned applesauce is the food prepared from comminuted or chopped apples (Malus domestica Borkhausen). Before, during, or after being chopped or comminuted, the apples may be peeled and cored. Additionally, the apples may have added thereto one or more of the optional ingredients specified in the 21CFR. The apple ingredient is heated and, in accordance with good manufacturing practices, bruised apple particles, peel, seed, core material, carpel tissue, and other coarse, hard, or extraneous materials are removed. The food is sealed in containers. It is so processed by heat, either before or after sealing, as to prevent spoilage. The soluble solids content, measured by refractometer and expressed as percent sucrose (degrees Brix) with correction for temperature to the equivalent at 20 deg. C. (68 deg. F.), is not less than 9 percent (exclusive of the solids of any added optional nutritive carbohydrate sweeteners) as determined by the method prescribed in “Official Methods of Analysis of the Association of Official Analytical Chemists,” 13th Ed. (1980), section 22.024, “Soluble Solids by Refractometer in Fresh and Canned Fruits, Jams, Marmalades, and Preserves—Official First Action,” which is incorporated by reference, but without correction for invert sugar or other substances.

As applesauce and other fruit and vegetable sauces reside in a highly competitive food product category, there is an increased need to develop novel sauces that have a distinctive taste, texture, and mouthfeel, and addresses common consumer concerns relating to caloric content.

In this disclosure, a new and novel fruit and vegetable sauce has been discovered that provides for a unique taste, texture, mouthfeel, and in some embodiments, may result in a sauce with reduced caloric content. The disclosure also describes new methods for manufacturing and dispensing these sauces.

### SUMMARY

In one exemplary embodiment of this disclosure, an aerated sauce is provided that comprises a fruit and/or vegetable puree, a stabilizer, a whipping agent, and entrained gas. In this particular embodiment, the stabilizer comprises at least one of hydrocolloids, gums, pectins, and gelatins, and the whipping agent comprises at least one of whey protein concentrate, egg albumin, and gelatin. The gas, puree, stabilizer, and whipping agent are mixed together to form an aerated sauce with a density of about 15 grams per ounce to about 25 grams per ounce.

In some of these embodiments, the ratio of puree to stabilizer is about 200:1.

In other embodiments, the ratio of puree to whipping agent is about 100:1.

In yet other embodiments, the puree is pureed apples.

In even other embodiments, the aerated sauce comprises between about 10% to about 50% entrained gas.

In some embodiments, the entrained gas comprises nitrous oxide.

In yet other embodiments, the entrained gas comprises carbon dioxide.

In further embodiments, the sauce may comprise ascorbic acid or erythorbic acid.

In other embodiments, the sauce comprises fat, which may comprise heavy cream, milk fat, vegetable oil, coconut oil, or palm kernel oil.

In yet other embodiments, the sauce may comprise an emulsifier.

In yet another embodiment, the aerated sauce has a percent overrun from about 50% to about 100%.

In some embodiments, the aerated sauce has a density of between about 18 grams per ounce to about 22 grams per ounce.

The aerated sauce of claim 1, wherein the stabilizer and whipping agent are both the same. In some of these embodiments, the stabilizer and whipping agent are both gelatin.

In yet another exemplary embodiment of the disclosure, a method for making an aerated sauce is provided. This method comprises the steps of pureeing a fruit or vegetable (or mixture thereof), heating the puree, adding a stabilizer to the heated puree, adding a whipping agent to the puree (either before or after it is heated or cooled), cooling the heated puree, and mixing a gas with the cooled puree. Mixing the gas with the cooled puree entrains at least some of the gas within the puree, thereby creating an aerated sauce.

In other embodiments of this method, the step of mixing the gas with the cooled puree comprises stream-blending the gas into the cooled puree.

In yet other embodiments of this method, the step of cooling the heated puree comprises cooling the puree to about a temperature of between about 70 degrees F. to about 90 degrees F.

In even other embodiments of this method, the step of heating the puree comprises heating the puree to a temperature of about 220 degrees F.

In another exemplary embodiment of this disclosure, a method for dispensing an aerated sauce is provided. This dispensing method comprises the steps of mixing a puree with a stabilizer and a whipping agent and packaging the sauce with liquefied gas in an aerosol container. In this embodiment, the puree comprises pureed fruit, pureed vegetables, or a mixture thereof. Upon the ejection of the sauce and liquefied gas from the container, an aerated sauce is formed. In a particular embodiment, nitrous oxide is the gas. In other embodiments, carbon dioxide is the gas.

In yet another exemplary embodiment of the disclosure, another aerated sauce is provided. In this particular embodiment, the aerated sauce comprises puree, entrained gas, and a stabilizer. The puree consists essentially of fruit and vegetable and the stabilizer comprises at least one of propylene glycol alginate, gum arabic, pectin, locust bean gum, guar gum, gellan gum, xanthan gum, gum ghatti, modified gum ghatti, tragacanth gum, carrageenan, pre-gelatinized starch, pre gelatinized high amylose-content starch, pregelatinized hydrolyzed starches, pregelatinized octenyl succinate substituted starch, cellulose gum, a carboxymethylcellulose. The gas, puree, and stabilizer are mixed together to form the aerated sauce, which comprises between about 10% to about 50% of entrained gas by volume.

In some of these embodiments, the aerated sauce also comprises a whipping agent, which includes at least one of whey protein concentrate, egg albumin, or gelatin.

In certain exemplary embodiments, the ratio of stabilizer to puree is between about 1:200 to about 2:100.

### DRAWINGS

Referring now to the figures, wherein the elements are numbered alike:

FIG. 1 is a schematic representation of a system for entraining gas into a sauce in accordance with an exemplary embodiment;

FIG. 2 is a schematic representation of a container for dispensing sauce in accordance with another exemplary embodiment of this disclosure; and

FIG. 3 is another schematic representation of a system for entraining gas into a sauce in accordance with another exemplary embodiment.

### DETAILED DESCRIPTION

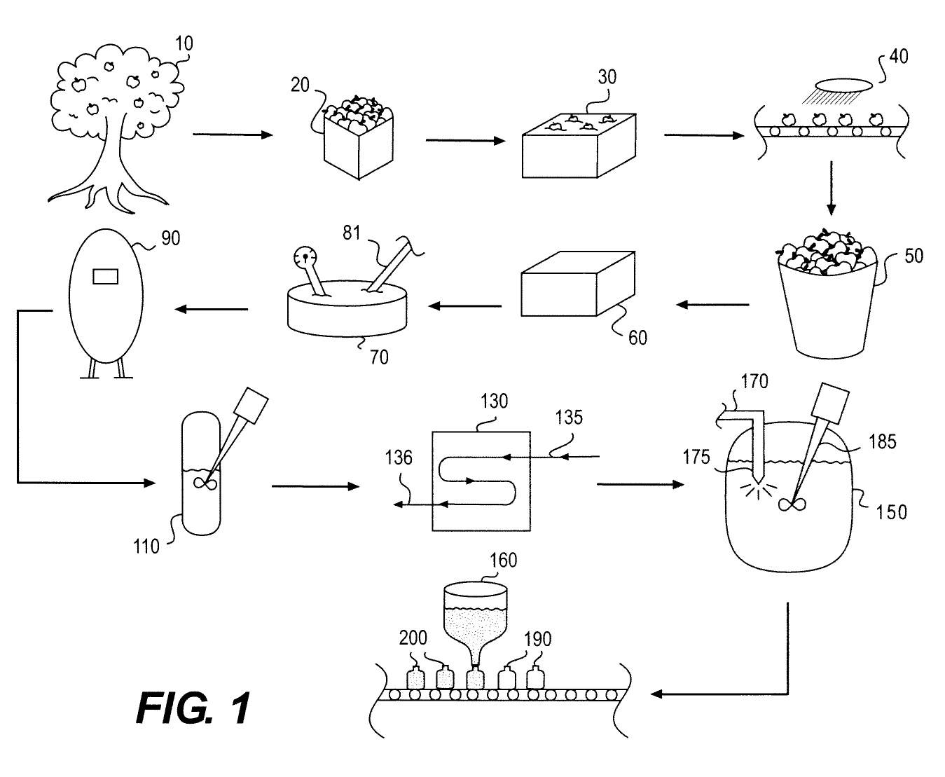

FIG. 1 depicts a method for preparing an aerated sauce in accordance with the disclosure. As defined in this disclosure, sauce includes any fruit or vegetable puree or mash and, in a preferred embodiment, the sauce comprises at least about 90% pureed fruit and vegetables, by weight. In the particular embodiment of FIG. 1, a system for preparing aerated applesauce is depicted. The reader should appreciate, however, that other fruit or vegetable sauces may be prepared in a similar manner.

As defined in this disclosure, aerated fruit or vegetable sauce includes any fruit or vegetable sauce (or combination thereof) with entrained or entrapped gas. In a particular embodiment of this disclosure, the aerated sauce comprises at least 10% (by volume) of entrained gas and at least 50% (by volume) of fruit or vegetable puree. Aerated sauce may also include, for example, non-fruit and non-vegetable ingredients, such as vitamins, minerals, preservatives, other food items, or functional ingredients, such as pharmaceuticals.

In a particular embodiment of this disclosure, the entrained gas is nitrous oxide, carbon dioxide, nitrogen, oxygen, and any mixture thereof, including air. The reader should appreciate, however, that these exemplary embodiments are not limiting and any other gas safe for consumption may be entrained in the sauce, as well.

The reader should also appreciate that, as used in this disclosure, the terms entrained and entrapped are synonymous with each other and used to describe the aeration of gas in a food sauce, such as applesauce.

In the particular system and method depicted in FIG. 1, apples are harvested from trees 10 and placed in a holding bin 20. It is fairly common for applesauce manufacturers to use a mixture of different apple varieties to achieve a desired applesauce taste and texture. For example, Red Delicious, Red Rome, Empire, Idared, Winesap, Jonathan, Stayman, McIntosh, Cortland, Rome Beauty, Delicious, York, Granny Smith, Braeburn, Elstar, Fuji, Gala, Royal Gala, Jonagold, Winter Banana, and other varieties may be used individually or in combination with any other apples. Furthermore, other fruit or vegetables may be added to create a diversified sauce blend.

From bin 20, apples are moved to washer 30, which comprises a water-filled tank. As the apples move floating on water in washer 30, loose dirt and other unwanted material is removed from their skin.

From washer 30, the apples are sent to scrubber 40, where the apples are mechanically scrubbed with a bristled-brush to further remove any unwanted material, such as sediment that may not have been removed while in washer 30.

After the apples are rinsed and scrubbed, they are sent to a hopper 50, which holds the apples prior to being received by extractor 60. Extractor 60 converts the apples into an apple mash by forcibly passing the apples through a screen, which simultaneously removes the majority of the apple peels and apple seeds. In a particular embodiment, the average particle size of the granular apple particles is about 1 millimeter. As an alternative to apple mash, which may comprise granular apple particles, the apples may alternatively be chopped into small pieces to create a chunky-textured applesauce. The applesauce's ability to entrain gas is related to granular particle size, however, and applesauce having smaller particle sizes will have a greater ability to entrain gas. Throughout this disclosure, the terms apple mash and applesauce may be used interchangeably, as both refer to apples that have been processed into relatively small apple particles.

In this particular embodiment, the apple mash exits extractor 60 at about room temperature and with an average particle size of about 1 millimeter.

After the apples are turned into an apple mash, the apple mash is cooked to a temperature of about 220 degrees F. Cooking the apples in this manner softens the apple particles and deactivates the enzymes inherently present, thereby minimizing further enzymatic reactions within the apple mash.

In one particular embodiment, the apple mash is sent from extractor 60 to heater 70. In this embodiment, heater 70 is a pressurized heater where steam from steam inlet 81 cooks the apple mash. In the particular embodiment shown in FIG. 1, the apple mash is heated by way of direct-steam injection to a temperature of about 220 degrees F. In this embodiment, steam is stream-blended with the apple mash, thereby directly heating the mash. One benefit of this particular heating method is that the apple mash may be heated relatively quickly. As the steam directly contacts the apple mash, however, some of the steam may condense into water, thereby diluting the apple mash with water.

Alternatively, the apple mash may be heated using indirect heating to prevent the dilution of the apple mash with water, thereby maintaining the consistency of the apple mash. In this particular embodiment, a heat exchanger (not shown) is used to transfer the thermal energy of the steam to the apple mash. The heat exchanger of this type may be a cross-flow, counter-flow, parallel-flow, or any other heat exchanger known in the art.

In yet another alternative embodiment, the heater (also not shown) may simply be a gas, electric, or any other heater or cooker known in the art that is capable of cooking the apple mash in a batch tank or in-stream, for example.

After exiting heater 70, the apple mash is transferred to flash tank 90, where it is returned back to atmospheric pressure and some water is flashed off, thereby cooling the apple mash slightly.

After exiting the flash tank 90, the apple mash is sent to sauce kettle 110, where other ingredients or additives may be added (e.g. other fruit or vegetable puree, cinnamon, vitamins, preservatives, colors, etc.).

In an exemplary embodiment of this disclosure, whipping agents, including but not limited to whey protein concentrate, egg albumin, and gelatin, are added to sauce kettle 110 to facilitate the apples mash's ability to entrap or entrain gas, such as during fluffing or whipping.

Stabilizers, including but not limited to hydrocolloids, gums, pectins, and gelatins, may also be added to the apple mash in kettle 110 to facilitate the apple mash's ability to entrap or entrain gas. The hydrocolloid composition may generally contain a natural gum, a synthetic gum, a starch, a modified starch, pectin, gelatin, an alginate, a modified alkylcellulose, or a combination comprising at least one of the foregoing. In a particular embodiment, the hydrocolloid composition comprises at least one of propylene glycol alginate, gum arabic, pectin, locust bean gum, guar gum, gellan gum, xanthan gum, gum ghatti, modified gum ghatti, tragacanth gum, carrageenan, pre-gelatinized starch, pre gelatinized high amylose-content starch, pregelatinized hydrolyzed starches, pregelatinized octenyl succinate substituted starch, cellulose gum, a carboxymethylcellulose, or a combination comprising at least one of the foregoing, but are not otherwise limited to these specific types.

In yet another particular embodiment, a combination of about 0.5% gellan gum and about 0.5% of cellulose gum (as stabilizers) mixed with applesauce resulted in a sauce with enhanced gas entrainment capabilities.

In the embodiment of FIG. 1, whipping agents and stabilizers are added to the apple mash in kettle 110 before being whipped. It has been discovered that the addition of whipping agents and stabilizers are particularly helpful in improving the gas retention of the apple mash in high-moisture environments, where the apple mash has relatively high water content.

In a particular embodiment, it has been discovered that adding about 1.0 grams of whipping agent and between about 0.5 grams to 2.0 grams of stabilizer for each 100 grams of applesauce (or apple mash) results in a sauce with good gas retention. Stated another way, about 200 parts mash, between about 1 to 4 parts stabilizer, and about 2 parts whipping agent provides for a sauce with enhanced gas retention.

After leaving kettle 110, the applesauce is sent to cooler 130, where it is cooled. The stabilizer forms into a gel when cooled with the applesauce in cooler 130. In particular, the stabilizer forms into a gel between about 70 degrees F. to about 90 degrees F. Immediate cooling of the applesauce and the formation of gel help to entrain the gas that will be introduced in the sauce-containing gel.

Cooler 130 may be any type of cooler or heat exchanger known in the art, such as a cross-flow, counter-flow, or parallel-flow heat exchanger that uses chilled water, refrigerant, or any other coolant or method of cooling to lower the temperature of the apple mash. In the particular embodiment shown in FIG. 1, cooler 130 comprises a chilled water coolant that enters coolant inlet line 135 and exits coolant exit line 136.

In a particular embodiment, the applesauce is cooled to a temperature of about 70 degrees F. In this embodiment, cellulose gum or pectin is used as the stabilizer and the ratio of stabilizer:sauce is between about 1:200 to about 2:100. Also in this embodiment, the resultant sauce is capable of entraining gas, such as nitrous oxide, up to about 50% by volume. In another particular embodiment, between about 10% to about 50% of the aerated sauce's volume results from the entrained gas.

The cooled applesauce is then sent from cooler 130 to aerator 150, which is open to atmospheric pressure. In at least this particular embodiment, pressurized gas from supply 170 is injected and dispersed into the applesauce via nozzle 175. In a particular embodiment, the nitrous oxide is injected at a pressure of about 70 psig. The gas and sauce combination is then mixed together with mixer 185. In this embodiment, mixer 185 is a mechanical mixer, such as one driven by an electric motor and commonly used in commercial food production.

In aerator 150, the gas and cooled applesauce are mixed with mixer 185 to facilitate entrapment of the gases in the applesauce. In aerator 150, mixer 185 “whips,” “fluffs,” and otherwise mixes the gas/applesauce combination, thereby aerating the gas into the sauce. As mentioned above, the resultant aerated applesauce will have a preferred density of about 15 grams per ounce to about 25 grams per ounce, and more particularly, will have a density of between about 18 grams per ounce to about 22 grams per ounce. As mentioned before, air, nitrous oxide, carbon dioxide, oxygen, nitrogen, or other gas, including a mixture of gases, is entrained in the applesauce as it is fluffed.

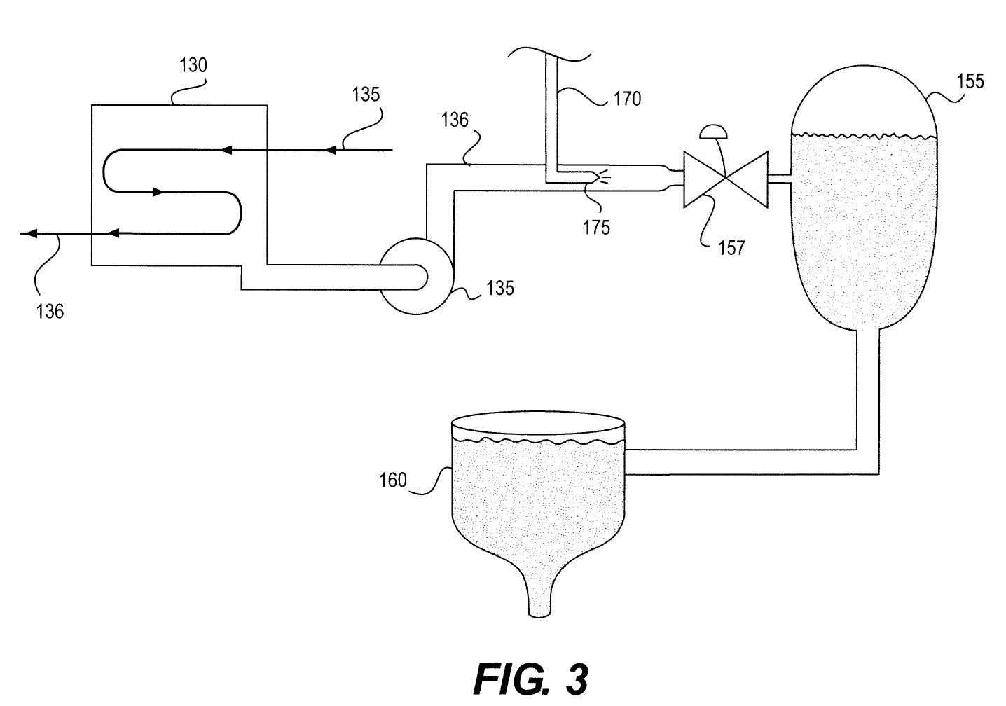

Referring now to FIG. 3, FIG. 3 illustrates an alternative system and method for entraining gas into the applesauce. In this particular embodiment, cooled applesauce is sent from cooler 130 to receiving tank 155 by way of pump 135 and via pipe 136. Pump 135 is a positive-displacement pump in this particular embodiment, but the reader should appreciate that other pumps may be used as known in the art. Also in this embodiment, pressurized gas (e.g. air, carbon dioxide, nitrous oxide, etc.) is stream-blended from supply 170 by injecting it at a relatively steady-rate. In particular, pressurized gas is injected into the applesauce through nozzle 175, which is located in pipe 136, downstream of pump 135, and upstream of back pressure valve 157. By introducing the gas through nozzle 175, the gas may be homogeneously dispersed in small bubbles into the sauce as the sauce is pumped from cooler 130 to tank 155. Back pressure valve 157 helps to maintain the point of injection at a constant pressure and facilitates the gas entrapment in a continuous, steady-state mode.

As mentioned above, the aerated applesauce disclosed herein may comprise any gas, including but not limited to carbon dioxide, nitrogen, oxygen, nitrous oxide, air, or any combination thereof. When the gas is fully entrained, the aerated applesauce may comprise about 10% to about 50% (by volume) of entrapped gas. As discussed above, the gas is introduced under pressure into the applesauce.

The aerated applesauce of this particular embodiment may have a density that is between about 15 grams per ounce to about 25 grams per ounce. As compared to other applesauce, the density of the aerated applesauce may be about 70% that of conventional applesauce.

In some embodiments of this disclosure, the applesauce may be sweetened with caloric or non-caloric sweeteners. In some embodiments, the soluble solids may fall within a range of about 18.0° brix to about 24.0° brix. Entraining nitrous oxide may also impart a perceived sweetness to the applesauce, thereby providing a non-caloric alternative to conventional caloric, low-caloric, or non-caloric sweeteners. As discussed in more detail, below, a particular embodiment of this disclosure comprises a sauce with entrained nitrous oxide.

Referring back to FIG. 1, the aerated applesauce is then sent from aerator 150 to filler 160, which fills the applesauce in empty containers 190. In this particular embodiment, containers 190 are exposed to atmospheric pressure and the filling process is open to atmosphere. Filled containers 200 are then packaged, processed, and delivered for consumption. The reader should appreciate that containers 190 may be glass jars, plastic tubes, plastic cups, or any other container known in the art.

In a preferred embodiment, container 200 is a rigid container. Using a rigid container may preserve the entrainment of gases in the applesauce during handling, as the consumer or handler is less likely to squeeze or deform container 200, which may result in inadvertent release or separation of a portion of the entrained gas in the sauce.

In yet another embodiment, heavy cream, milk fat, or other fat, such as vegetable oils, including coconut and palm kernel oil, can be added to the applesauce prior to whipping. In an exemplary embodiment, about 2% of such fat or oil is added prior to entraining the gas. In these embodiments, as the sauce is whipped, the fat particles will coat the incorporated gases and will impart a creamy texture to the product. After the addition of fat and prior to whipping, the applesauce may be homogenized to help distribute the fat in the applesauce. Whey protein or egg albumin may then be added to enhance whipping, and may also function as emulsifiers to prevent the fat from separating.

In another preferred embodiment, the aerated applesauce contains a preservative. Adding a preservative may allow the applesauce to be cold-filled without the need for pasteurization. The preservatives may chemically inhibit any undesired microbial growth, thereby extending shelf-life.

In at least some of these embodiments, ascorbic acid and erythorbic acid are added to help minimize oxidation of iron, which is a common mineral found in applesauce. Ascorbic acid acts as a preservative to help extend the shelf-life of the sauce. Oxidation of iron turns applesauce brown, so the addition of ascorbic acid helps prevent the applesauce from browning. If air is entrained in the sauce, the ascorbic acid will degrade more quickly, thereby requiring a larger addition of ascorbic acid. In at least one exemplary embodiment, about 350 parts per million of ascorbic acid is added.

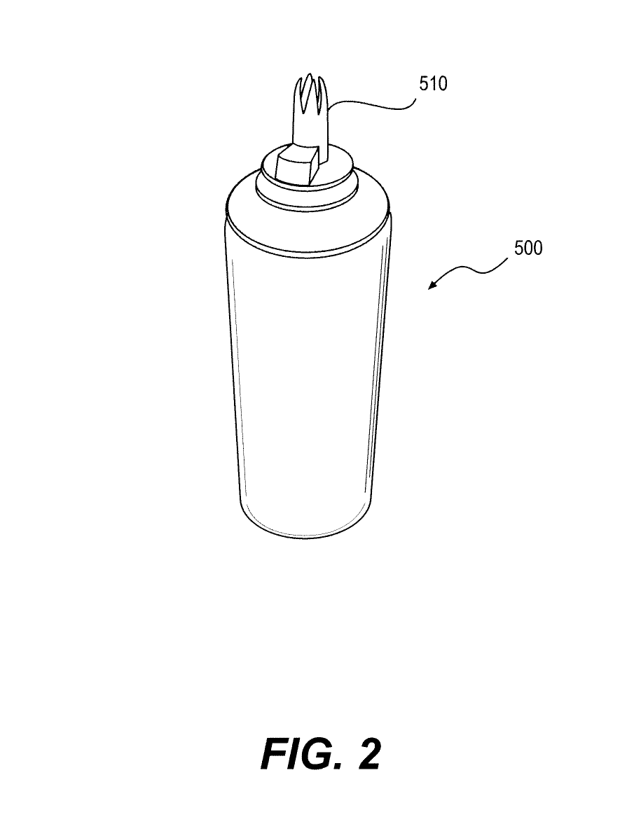

In at least some embodiments, applesauce is dispensed from a pressurized aerosol container 500, which is shown in FIG. 2. In a particular embodiment, container 500 is the container disclosed in U.S. Pat. No. 2,704,172 to Aaron S. Lapin, issued on Mar. 15, 1955. Prior to being packaged in container 500, there is relatively little-to-no gas entrained in the applesauce, but the applesauce does comprise a stabilizer, as disclosed in other embodiments. The relatively gas-free applesauce is packaged into container 500 along with liquefied gas, which is under pressure. When the pressurized applesauce and liquefied gas are dispensed through nozzle 510, the liquefied gas expands and is simultaneously released with the sauce, thereby entraining the gas into the applesauce. The expansion of the pressurized gas as it is expelled from the nozzle cools the applesauce, thereby ‘setting’ the gel created by the stabilizer. The pressurized gas also acts as a propellant, facilitating dispensing of the applesauce from container 500.

In an exemplary embodiment of FIG. 2, nitrous oxide is used and container 500 is pressurized up to about 100 psig, thereby retaining the gas in a liquid state within container 500. When the applesauce is in container 500, it will have a density of about 28 grams/oz. When the applesauce is dispensed from container 500 via nozzle 510, the nitrous oxide will expand to its gaseous state and will simultaneously aerate the applesauce. The resulting aerated applesauce will have a density of about 15 grams per ounce to about 25 grams per ounce. In a particular embodiment, the density of the applesauce is about 19 grams per oz.

Fluffing the applesauce with nitrous oxide enhances the mouthfeel and texture of the applesauce by imparting a creamy-like texture. Furthermore, the nitrous oxide enhances the sweetness of the applesauce without otherwise increasing the caloric content, as nitrous oxide imparts a perceived sweetness to food and beverage items when consumed, as disclosed in U.S. Patent Publication Number US 2010/0009052 A1.

In other embodiments, carbon dioxide is the entrained gas. Carbon dioxide enhances the flavor, sweetness, taste, and mouth-feel of the composition. Additionally, use of carbon dioxide lowers the pH of the composition, thereby enhancing the sauce's microbial stability.

In another exemplary embodiment of this disclosure, an applesauce is provided that has a density of about 15 grams per ounce to about 25 grams per ounce. The ingredients of this particular embodiment are provided in the below TABLE 1:

TABLE 1

| Ingredient | Weight (%) |
|---|---|
| Pureed Apples | 98.15 |
| Carrageenan | 0.35 |
| Whey Protein Concentrate | 1.00 |
| Cellulose Gum | 0.40 |
| Sodium Benzoate | 0.05 |
| Potassium Sorbate | 0.05 |

In the particular applesauce disclosed in Table 1, it was revealed that the applesauce exhibited enhanced creaminess, as compared to conventional applesauce, when gas, such as nitrous oxide, is entrained in the applesauce. In a particular embodiment, it was discovered that entraining nitrous oxide in a concentration of about 8 grams to 500 mL (which results in a density of about 19 grams per ounce) provides for an applesauce with enhanced creaminess. The reader should appreciate, however, that a portion of the gas is not entrapped with the applesauce and is instead primarily used to expel the product from the canister.

In yet another exemplary embodiment, it was discovered that entraining carbon dioxide in the applesauce of Table 1 provided for an applesauce with enhanced tartness, as compared to conventional applesauce. This enhanced tartness more closely resembled taste characteristics often associated with Granny Smith apples.

In another preferred embodiment, the sauce of the current disclosure comprises a percent overrun from about 50% to about 100%.

Percent overrun is the percent increase in volume, as measured from the original volume. Percent overrun is a term commonly used in the ice cream industry. For example if 1 gallon of ice cream mix was whipped into 1.5 gallons of finished ice cream, a 50% overrun has been achieved. Percent overrun is used to describe the ‘fluffiness’, ‘airiness’ or ‘creaminess’ of a product. As some might describe, a higher percentage overrun may indicate more creaminess.

Additionally, in some of the applesauce embodiments, the pH of the applesauce may fall within a range of about 1.5 to about 6.0, and more particularly, about 3.0 to about 4.2.

While the invention has been described with reference to a few exemplary embodiments, it is understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An aerated sauce, said aerated sauce comprising:
puree, said puree comprising fruit, vegetables, or a mixture thereof;
a stabilizer;
a whipping agent; and
entrained gas;
wherein the stabilizer comprises at least one of hydrocolloids, gums, pectins, and gelatins,
wherein the whipping agent comprises at least one of whey protein concentrate, egg albumin, and gelatin,
wherein the gas, puree, stabilizer, and whipping agent are mixed together to form the aerated sauce, and
wherein the density of the aerated sauce is between about 15 grams/oz to about 25 grams/oz.

2. The aerated sauce of claim 1, wherein the ratio of puree to stabilizer is about 200:1.

3. The aerated sauce of claim 1, wherein the ratio of puree to whipping agent is about 100:1.

4. The aerated sauce of claim 1, wherein the puree is pureed apples.

5. The aerated sauce of claim 1, wherein aerated sauce comprises between about 10% to about 50% entrained gas.

6. The aerated fruit sauce of claim 1, wherein the entrained gas comprises nitrous oxide.

7. The aerated fruit sauce of claim 1, wherein the entrained gas comprises carbon dioxide.

8. The aerated fruit sauce of claim 1, further comprising ascorbic acid or erythorbic acid.

9. The aerated sauce of claim 1, further comprising fat.

10. The aerated sauce of claim 9, wherein the fat consists essentially of heavy cream, milk fat, vegetable oil, coconut oil, or palm kernel oil.

11. The aerated sauce of claim 9, further comprising an emulsifier.

12. The aerated sauce of claim 1, wherein the aerated sauce comprises a percent overrun from about 50% to about 100%.

13. The aerated sauce of claim 1, wherein the density of the aerated sauce is from about 18 grams/oz to about 22 grams/oz.

14. The aerated sauce of claim 1, wherein the stabilizer and whipping agent are both the same.

15. The aerated sauce of claim 14, wherein the stabilizer and whipping agent is a gelatin.

16. A method for making an aerated sauce, said method comprising the steps of:
pureeing a fruit or vegetable to form a puree;
heating the puree;
adding a stabilizer to the heated puree;
adding a whipping agent to the puree;
cooling the heated puree; and
mixing a gas with the cooled puree, wherein mixing the gas with the cooled puree entrains at least some of the gas within the puree, thereby creating an aerated sauce.

17. The method of claim 16, wherein the step of mixing the gas with the cooled puree comprises stream-blending the gas into the cooled puree.

18. The method of claim 16, wherein the step of cooling the heated puree comprises cooling the puree to about a temperature of between about 70 degrees F. to about 90 degrees F.

19. The method of claim 16, wherein the step of heating the puree comprises heating the puree to a temperature of about 220 degrees F.

20. The method of claim 16, wherein the aerated sauce comprises between about 10% to about 50% of entrained gas by volume.

21. The method of claim 16, further comprising the step of adding ascorbic acid or erythorbic acid.

22. A method for dispensing an aerated sauce, said method comprising the steps of:
providing a puree, said puree comprising pureed fruit, pureed vegetables, or a mixture thereof;
providing a stabilizer;
providing a whipping agent;
mixing the stabilizer, whipping agent, and puree to form a sauce;
packaging the sauce and a liquefied gas in a pressurized aerosol container, said pressurized aerosol container comprising a dispensing valve;
ejecting the sauce from the pressurized container upon the opening of the dispensing valve; and
forming an aerated sauce when the sauce and liquefied gas are ejected from the container.

23. The method of claim 22, wherein the gas comprises nitrous oxide.

24. The method of claim 22, wherein the gas comprises carbon dioxide.

25. An aerated sauce, said aerated sauce comprising:
puree, said puree consisting essentially of fruit and vegetable;
entrained gas; and
a stabilizer, said stabilizer comprising at least one of propylene glycol alginate, gum arabic, pectin, locust bean gum, guar gum, gellan gum, xanthan gum, gum ghatti, modified gum ghatti, tragacanth gum, carrageenan, pre-gelatinized starch, pre gelatinized high amylose-content starch, pregelatinized hydrolyzed starches, pregelatinized octenyl succinate substituted starch, cellulose gum, a carboxymethylcellulose, and
wherein the gas, puree, and stabilizer are mixed together to form an aerated sauce, and
wherein the aerated sauce comprises between about 10% to about 50% of entrained gas by volume.

26. The aerated sauce of claim 25, further comprising a whipping agent, said whipping agent comprising at least one of whey protein concentrate, egg albumin, or gelatin.

27. The aerated sauce of claim 25, wherein the ratio of stabilizer to puree is between about 1:200 to about 2:100.
